(19) United States
(12) Patent Application Publication
(10) Pub. No.: US 2025/0193826 A1
(43) Pub. Date: Jun. 12, 2025

(54) A METHOD, DEVICE, APPARATUS AND COMPUTER-READABLE MEDIUM FOR COMMUNICATION

(71) Applicant: Nokia Technologies Oy, Espoo (FI)

(72) Inventors: Chunli WU, Beijing (CN); Benoist Pierre SEBIRE, Tokyo (JP); Samuli Heikki TURTINEN, Oulu (FI)

(21) Appl. No.: 18/845,048

(22) PCT Filed: Mar. 10, 2022
(86) PCT No.: PCT/CN2022/080219

§ 371 Date: Sep. 9, 2024

(51) Int. Cl. H04W 60/04; H04W 56/00; H04W 72/1268

(52) U.S. Cl. CPC H04W 60/04; H04W 56/0045; H04W 72/1268

(57) ABSTRACT

Embodiments of the present disclosure relate to devices, methods, apparatuses and computer-readable storage medium for communication. In some example embodiments, a terminal device receives an indication for a retransmission of a protocol data unit comprising data of a Data Radio Bearer (DRB). The terminal device activates, at the terminal device, a target secondary Radio Link Control (RLC) entity of one or more secondary RLC entities configured for the data of the DRB, the target secondary RLC entity being associated with at least one serving cell that is in an activated mode or in an activation procedure.

### TECHNICAL FIELD

Embodiments of the present disclosure generally relate to the field of telecommunication, and in particular, to devices, methods, apparatuses and computer-readable storage media for communication.

### BACKGROUND

With the development of communication technology, in order to meeting different communication requirements, more and more technologies have been introduced to enhance the reliability of a transmission procedure. For example, Packet Data Convergence Protocol (PDCP) duplication for data of a Data Radio Bearer (DRB) has been introduced to enable redundant transmission of the data of the DRB. In the PDCP duplication, one or more secondary Radio Link Control (RLC) entities of a terminal device and corresponding one or more secondary RLC entities of a network device are configured for a transmission of the data of the DRB, wherein a Logical Channel (LCH) between a RLC entity of the terminal device and a corresponding RLC entity of the network device is mapped to one or more serving cells. Conventionally, a network device may decide to activate which secondary RLC entity (ies) and serving cell(s) and instruct to activate the decided secondary RLC entity (ies) and serving cell(s) via a Medium Access Control (MAC) Control Element (CE) of Physical Downlink Shared Channel (PDSCH). Then, with the received MAC CE, the terminal device can activate the corresponding the RLC entity (ies) for transmitting the data of the DRB, such that the data of the DRB can be transmitted in different RLC entity legs.

In this way, the terminal device and network device individually activates all (or a subset of) the secondary RLC entities for transmitting the data of the DRB to transmit the data of the DRB in different RLC entity legs. In addition to the optimization of the reliability, the latency performance in this mechanism may be further optimized.

### SUMMARY

In general, example embodiments of the present disclosure provide devices, methods, apparatuses and computer-readable storage media for communication.

In a first aspect, there is provided a terminal device. The terminal device comprises at least one processor and at least one memory including computer program code. The at least one memory and the computer program code configured to, with the at least one processor, cause the terminal device to receive an indication for a retransmission of a protocol data unit comprising data of a Data Radio Bearer (DRB). The terminal device is further caused to activate, at the terminal device, a target secondary Radio Link Control (RLC) entity of one or more secondary RLC entities configured for the data of the DRB, the target secondary RLC entity being associated with at least one serving cell that is in an activated mode or in an activation procedure.

In a second aspect, there is provided a network device. The network device comprises at least one processor and at least one memory including computer program code. The at least one memory and the computer program code configured to, with the at least one processor, cause the network device to transmit an indication for a retransmission of a protocol data unit comprising data of a Data Radio Bearer (DRB). The network device is further caused to activate, at the network device, a target secondary Radio Link Control (RLC) entity of one or more RLC entities configured for the data of the DRB, the target secondary RLC entity being associated with at least one serving cell that is in an activated mode or in an activation procedure.

In a third aspect, there is provided a method implemented in a terminal device. In the method, the terminal device receives an indication for a retransmission of a protocol data unit comprising data of a Data Radio Bearer (DRB). The terminal device further activates, at the terminal device, a target secondary Radio Link Control (RLC) entity of one or more secondary RLC entities configured for the data of the DRB, the target secondary RLC entity being associated with at least one serving cell that is in an activated mode or in an activation procedure.

In a fourth aspect, there is provided a method implemented in a network device. In the method, the network device transmits an indication for a retransmission of a protocol data unit comprising data of a Data Radio Bearer (DRB). The network device further activates, at the network device, a target secondary Radio Link Control (RLC) entity of one or more RLC entities configured for the data of the DRB, the target secondary RLC entity being associated with at least one serving cell that is in an activated mode or in an activation procedure.

In a fifth aspect, there is provided an apparatus implemented in a terminal device comprising means for performing the method according to the third aspect.

In a sixth aspect, there is provided an apparatus implemented in a network device comprising means for performing the method according to the fourth aspect.

In an seventh aspect, there is provided computer-readable storage medium having instructions stored thereon. The instructions, when executed on at least one processor, cause the least one processor to perform the method to any of the third to fourth aspects. Other features of the present disclosure will become easily comprehensible

through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example environment in which example embodiments of the present disclosure can be implemented;

FIG. 2 illustrates an example method implemented in a terminal device in accordance with some example embodiments of the present disclosure;

FIG. 3 illustrates an example method implemented in a network device in accordance with some example embodiments of the present disclosure; and

FIG. 4 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, terminal device, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, devices for Integrated Access and Backhaul (IAB), or image capture devices such as digital cameras, gaming devices, music storage and playback appliances, or Internet appliances enabling wireless or wired Internet access and browsing and the like. Herein, the term “terminal device” can be used interchangeably with a UE.

As used herein, the term “network device” refers to a device which is capable of providing or hosting a cell or coverage where a terminal device, can communicate with. Examples of a network device include, but not limited to, a Node B (NodeB or NB), an Evolved NodeB (eNodeB or eNB), a next generation eNB (ng-eNB), a ng-eNB-Central Unit (ng-eNB-CU), a ng-eNB-Distributed Unit (ng-eNB-DU), a next generation NodeB (gNB), a gNB-Central Unit (gNB-CU), a gNB-Distributed Unit (gNB-DU), a Remote Radio Unit (RRU), a radio head (RH), a remote radio head (RRH), an Integrated Access and Backhaul (IAB) node, a low power node such as a femto node, a pico node, and the like. In some communication systems, the network device may be consist of multiple separate entities, for example, in NTN system, the network device may be consist of radio frequency part located in satellites or drones, and inter-frequency/base band part located in ground stations.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term ‘includes’ and its variants are to be read as open terms that mean “includes, but is not limited to”. The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. The terms “first”, “second” and the like may refer to different or same objects. Other definitions, explicit and implicit, may be included below.

As mentioned above, the data transmission latency and reliability performance may be further optimized, for example, the activation of secondary RLC entities which is based on MAC CE may cannot meet a time requirement specific to some communication traffics, since the decoding procedure for the MAC CE cannot meet the requirement in the order of 0.5 ms. For this, a terminal device may active secondary RLC entities without based on a MAC CE. For example, with UE-based PDCP duplication activation (e.g. for DRB configured with survivalTimeStateSupport), the network device may schedule the retransmission for the data of the DRB via an indication other than the MAC CE, and the activation of PDCP duplication of the DRB for the secondary RLC entities may be triggered by this indication. The indication may be an uplink grant for the retransmission of a PDU that comprises the data of the DRB, which is transmitted in Physical Downlink Control Channel (PDCCH). However, since the activation of the serving cells is still based on MAC CE, the data from the activated secondary RLC entity might not be able to be transmitted as the serving cells associated with the secondary RLC entities configured for the data of the DRB may be not in an activated mode. It has not been discussed how to ensure a successful transmission in the secondary RLC entity leg under the “UE-based PDCP duplication activation”.

Example embodiments of the present disclosure provide a scheme for improving activation of PDCP duplication. In this scheme, the terminal device receives an indication for a retransmission of a PDU comprising data of a DRB. Then, the terminal device determines a target secondary RLC entity from one or more secondary RLC entities configured for the data of the DRB, the target secondary RLC entity is associated with at least one serving cell that is in an activated mode or in an activation procedure. The target secondary RLC entity is associated with the at least one serving cell if the serving cell is configured as allowed serving cell for the LCH of the target secondary RLC entity. The terminal device activates the determined target secondary RLC entity for transmitting the data of the DRB. Correspondingly, at the network device side, the network device determines and activates the corresponding target secondary RLC entity for receiving the data of the DRB.

In this way, in case that the terminal device enters Survival Time state for the DRB to activate PDCP duplication, the terminal device and network device can determine and only activate current available secondary RLC entity legs configured for the data of the DRB.

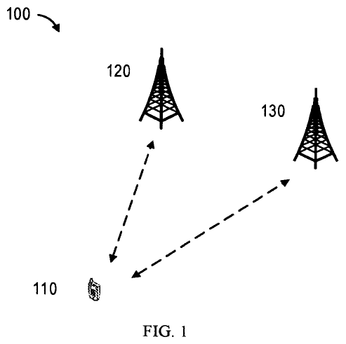

FIG. 1 illustrates an example environment 100 in which example embodiments of the present disclosure can be implemented.

The environment 100, which may be a part of a data communication network, comprises a terminal device 110, a network device 120 and a network device 130. In the environment 100, the terminal device 110 is served by one or more serving cells provided by the network device 120 and/or the network device 130. The terminal device 110 and network device 120 (or the network device 130) both have the knowledge of a RLC entity leg between a RLC entity at the terminal device 110 and a corresponding RLC entity at the network device 120 (or a corresponding RLC entity at the network device 130). Further, the RLC entity has a logical channel which mapped to one or more serving cells.

It is to be understood that the number of the terminal device and the network device is shown in the environment 100 only for the purpose of illustration, without suggesting any limitation to the scope of the present disclosure. In some example embodiments, the environment 100 may comprise a further terminal device and/or a further network device. In an example, in a dual-connectivity scenario, the terminal device 110 may be connected to a data network via the network device 120 and the network device 130. In this case, the activation of duplication of DRB for the secondary RLC entity may be performed on secondary RLC legs between the terminal device 110 and the network device device 120, and the secondary RLC legs between the terminal device 110 and the network device 130, simultaneously. The activation of duplication of DRB for secondary DRB may be performed with respect to the terminal device 110 and different network devices.

The terminal device 110 can communicate with the network device 120 or with a further terminal device (not shown) directly or via the network devices. The terminal device 120 can communicate with the network device 130 by wired (for example, optical fiber communication) or wireless communication technologies. The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

For discussion clarity, the following embodiments are described with respect to the connectivity between the terminal device 110 and the network device 120. However, it is to be understood that the following embodiments can be implemented in a dual connectivity which the terminal device 110 connects to a data network via the network device 110 and the network device 120. In a dual connectivity, the further network device may activate the secondary RLC entities in the same way as discussed regarding the network device 120.

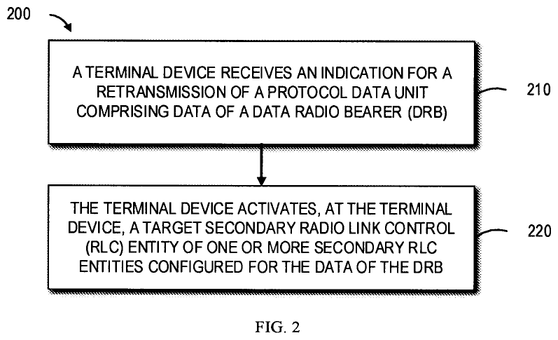

FIG. 2 illustrates an example method 200 implemented in a terminal device in accordance with some example embodiments of the present disclosure.

The method of 200 can be implemented at the terminal device 110 shown in FIG. 1. For the purpose of discussion, the method 200 will be described with reference to FIG. 1. It is to be understood that the method 200 may include additional acts not shown and/or may omit some shown acts, and the scope of the present disclosure is not limited in this regard.

At 210, the terminal device 110 receives an indication for a retransmission of a protocol data unit comprising data of a DRB. In some embodiments, the terminal device 110 receives the uplink grant for the retransmission of the protocol data unit in a PDCCH. For example, the network device 120 detects a reception failure of a protocol data unit comprising data of a DRB, and the DRB has a requirement for survival time, the network device 120 may transmit a uplink grant for the retransmission of the protocol data unit to the terminal device 110. In some embodiments, the DRB is configured with a PDCP duplication, and the duplication is based on an uplink grant for the retransmission of the protocol data unit (e.g. configured with survivalTimeStateSupport). For example, if the DRB is configured with a PDCP duplication and survivalTimeStateSupport, upon receiving the uplink grant for the retransmission of the protocol data unit, the terminal device 110 may activate PDCP duplication for RLC entities which are configured for the data of the DRB. Then, the terminal device 110 may, respectively, transmit the data of the DRB via the RLC entities are activated with PDCP duplication.

In addition or alternatively to the uplink grant, in some embodiments, the terminal device 110 may receive the indication by receiving a Negative-Acknowledge (NACK) for the packet unit from the network device 120. In some other embodiments, the terminal device 110 may receive the indication by receiving a specific signaling or a certain field in common signaling.

At 220, the terminal device 110 activates a target secondary RLC entity of one or more secondary RLC entities configured for the DRB. The target secondary RLC entity is associated with at least one serving cell that is in an activated mode or in an activation procedure. As mentioned above, the indication for the retransmission of the PDU comprises data of DRB, for example, the uplink grant for the retransmission, such that the activation of serving cells which is also based on the MAC CE has not been performed when the terminal device 110 is ready for transmit the data of the DRB. In this case, in order to avoid blindly activating all the secondary RLC entities configured for the data of the DRB, the terminal device 110 only activates secondary RLC entities with available activated serving cells (as the target RLC entities) of the RLC entities configured for the DRB. For simplicity, the RLC entities with available activated serving cells or serving cell in activation procedure meeting time requirement may also referred as “current available secondary RLC entity”.

In some embodiments, the terminal device 110 may determine current available secondary RLC entities from the one or more secondary RLC entities configured for the data of the DRB as the target RLC entity and activate these target RLC entities. In some embodiments, the terminal device 110 may determine the secondary RLC entities associated with at least on activated serving cell as the target RLC entities. In this case, the terminal device 110 may detect one or more serving cells to which the logical channels of a secondary RLC entity mapped. If the terminal device 110 detects that at least one of these serving cells is in activated mode, the terminal device 110 may determine the secondary RLC entity as a target RLC entity.

In some embodiments, the terminal device may also consider the secondary RLC entities associated with serving cells which is in activation procedure. For example, if a serving cell in the activation procedure will enter the activated mode soon, for example, the remaining duration of the activation procedure is smaller than a threshold, the terminal device 110 may determine the secondary RLC entity associated with this serving cell as a target RLC entity.

In some embodiments, a delay threshold may be predefined for an activation of the target secondary RLC entity. In this case, the terminal device 110 may calculate the remaining duration required by the activation procedure of a serving cell. If the remaining duration is smaller than the delay threshold, the terminal device 110 may determine a secondary RLC entity associated with the serving cell which is in the activation procedure as the target secondary RLC entity. In some embodiments the delay threshold may be configured/adjusted by the terminal device 110 and network device 120 on demand.

In some embodiments, the terminal device 110 may only consider secondary RLC entities associated with activated serving cells which are configured uplink transmission. For example, if there is a RLC entity associated with an activated serving cell that is only configured with downlink transmission, the terminal device 110 may not activate this secondary RLC entity. In turn, if there is an activated serving cell that is configured with uplink transmission, the terminal device 110 may activate the secondary RLC entity associated with this activated serving cell. As such, the retransmission of the data of the DRB can be performed immediately without waiting for the uplink grant for a serving cell.

In some embodiments, the uplink synchronization of serving cells is also considered by the terminal device 110. For example, the terminal device 110 may only consider secondary RLC entities associated with activated serving cells which are in a Timing Advance Group (TAG), and the TAG has a running Timing Alignment Timer (TAT). Further, if the TAT of the TAG comprising the serving cell is not running, then the RLC entity associated with the serving cell will not be activated.

In this case, the terminal device 110 may determine a secondary RLC entity associated with activated serving cells which are in a Timing Advance Group (TAG) as the target secondary RLC entity. As such, the transmission of the data of the DRB can be performed immediately without waiting for timing adjustment operations.

In some embodiments, after the target secondary RLC entities has been determined, the terminal device 110 may indicate to a PDCP layer that an activation of Packet Data Convergence Protocol (PDCP) duplication for the target secondary RLC entity. In some embodiments, the terminal device 110 may further indicate to other upper layers.

In some embodiments, if the terminal device 110 determines that there is no secondary RLC entity associated with activated serving cell or a serving cell in an activation procedure, the terminal device 110 may determine to activate no secondary RLC entity in order to avoid meaningless activation operation.

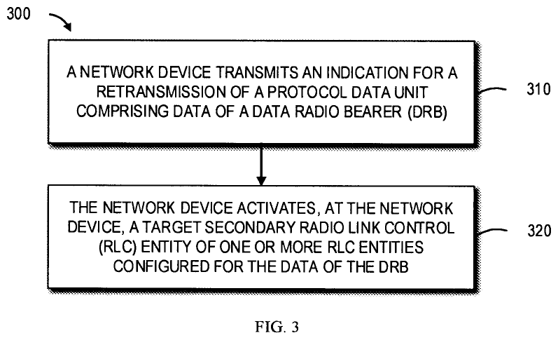

FIG. 3 illustrates an example method 300 implemented in a network device in accordance with some example embodiments of the present disclosure.

The method 300 can be implemented at the network device 120 shown in FIG. 1. For the purpose of discussion, the method 300 will be described with reference to FIG. 1. It is to be understood that the method 300 may include additional acts not shown and/or may omit some shown acts, and the scope of the present disclosure is not limited in this regard.

At 310, the network device 120 transmits an indication for a retransmission of a protocol data unit comprising data of a Data Radio Bearer (DRB). For example, as discussed above, the network device 120 detects a reception failure of a packet unit comprising data of a DRB, and the DRB has a requirement for survival time, the network device 120 may transmit a uplink grant for the retransmission of the protocol data unit to the terminal device 110.

At 320, the network device 120 activates, at the network device, a target secondary RLC entity of one or more RLC entities configured for the data of the DRB, the target secondary RLC entity being associated with at least one serving cell that is in an activated mode or in an activation procedure. In some embodiments, the network device 110 may active the target secondary RLC in the same way as the terminal device 110. For example, the network device 120 may consider RLC entities associated with serving cells which are in activated mode or in an activation procedure, consider RLC entities associated with activated cells configured with uplink transmission, or consider RLC entities associated with activated cells in a TAC having a running TAT. In some embodiments, the activation rules of RLC entities configured for the data of the DRB are predetermined between the terminal device 110 and the network device 120.

In some embodiments, the network device 120 may activate serving cells in response to detecting a trigger event associated with a retransmission of the protocol data unit comprising the data of the DRB. For example, upon scheduling a retransmission uplink grant for a protocol data unit comprising the data of the DRB, the network device 120 may activate at least one serving cell associated with each of one or more secondary RLC entities configured for the data of the DRB. In addition or alternatively, upon transmitting the retransmission uplink grant to the terminal device or receiving, from an activated secondary RLC entity of the terminal device, the network device 120 may activate at least one serving cell associated with each of one or more secondary RLC entities configured for the data of the DRB.

In addition or alternatively, in order to ensure each RLC entity leg, the network device 120 may instruct at least one serving cell associated with the RLC entity configured for the data of the DRB to maintain in the activated mode, and configure the at least one serving cell being with uplink transmission.

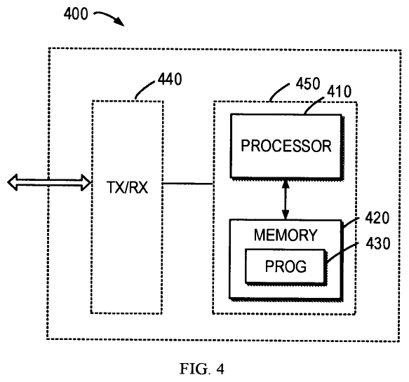

FIG. 4 is a simplified block diagram of a device 400 that is suitable for implementing example embodiments of the present disclosure. The device 400 can be implemented at the terminal device 110, the network device 120 as shown in FIG. 1.

As shown, the device 400 includes a processor 410, a memory 420 coupled to the processor 410, a communication module 430 coupled to the processor 410, and a communication interface (not shown) coupled to the communication module 430. The memory 420 stores at least a program 440. The communication module 430 is for bidirectional communications, for example, via multiple antennas or via a cable. The communication interface may represent any interface that is necessary for communication.

The program 440 is assumed to include program instructions that, when executed by the associated processor 410, enable the device 400 to operate in accordance with the example embodiments of the present disclosure, as discussed herein with reference to FIGS. 2 to 3. The example embodiments herein may be implemented by computer software executable by the processor 410 of the device 400, or by hardware, or by a combination of software and hardware. The processor 410 may be configured to implement various example embodiments of the present disclosure.

The memory 420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 420 is shown in the device 400, there may be several physically distinct memory modules in the device 400. The processor 410 may be of any type suitable to the local technical network, and may include one or more of general purpose computers, special purpose computers, microprocessors, digital signal processors (DSPs) and processors based on multicore processor architecture, as non-limiting examples. The device 400 may have multiple processors, such as an application specific integrated circuit chip that is slaved in time to a clock which synchronizes the main processor.

When the device 400 acts as the terminal device 110, the processor 410 may implement the operations or acts of the terminal device 110 as described above with reference to FIG. 2. When the device 00 acts as the network device 120, the processor 10 may implement the operations or acts of the network device 120 as described above with reference to FIG. 3. All operations and features as described above with reference to FIGS. 1 to 4 are likewise applicable to the device 400 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the operations and acts as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a terminal device comprises at least one processor; and at least one memory including computer program code; and the at least one memory and the computer program code configured to, with the at least one processor, cause the terminal device to receive an indication for a retransmission of a protocol data unit comprising data of a Data Radio Bearer (DRB). The terminal device is further caused to activate, at the terminal device, a target secondary Radio Link Control (RLC) entity of one or more secondary RLC entities configured for the data of the DRB, the target secondary RLC entity being associated with at least one serving cell that is in an activated mode or in an activation procedure.

In some embodiments, the at least one serving cell is in a Timing Advance Group (TAG), and the TAG having a Time Alignment Timer (TAT) that is running.

In some embodiments, the at least one serving cell is configured with uplink transmission.

In some embodiments, a remaining duration of the activation procedure is smaller than a delay threshold predefined for an activation of the target secondary RLC entity.

In some embodiments, the terminal device is further caused to: determine whether there is a secondary RLC entity associated with a serving cell that is in an activated mode or in an activation procedure; and in accordance with a determination that there is no secondary RLC associated with a serving cell that is in an activated mode or in an activation procedure, activate no secondary RLC entity.

In some embodiments, the terminal device is caused to receive the indication by: receiving an uplink grant for the retransmission of the protocol data unit in a Physical Downlink Control Channel (PDCCH).

In some embodiments, the DRB is configured with a PDCP duplication which is based on an uplink grant for the retransmission of the protocol data unit.

In some embodiments, the terminal device is further caused to: indicate, to a upper layer, an activation of Packet Data Convergence Protocol (PDCP) duplication for the target secondary RLC entity, the upper layer comprising a PDCP layer.

In some embodiments, the at least one serving cell is configured as allowed serving cell for a logical channel of the target secondary RLC entity.

In some aspects, a network device comprises at least one processor and at least one memory including computer program code; and the at least one memory and the computer program code configured to, with the at least one processor, cause the network device to transmit an indication for a retransmission of a protocol data unit comprising data of a Data Radio Bearer (DRB). The network device is further caused to activate, at the network device, a target secondary Radio Link Control (RLC) entity of one or more RLC entities configured for the data of the DRB, the target secondary RLC entity being associated with at least one serving cell that is in an activated mode or in an activation procedure.

In some embodiments, the network device is further caused to activate at least one serving cell associated with each of one or more secondary RLC entities configured for the data of the DRB in response to at least one of: scheduling a retransmission uplink grant for a protocol data unit comprising the data of the DRBprotocol data unit; transmitting the retransmission uplink grant to the terminal device; and receiving, from an activated secondary RLC entity of the terminal device, the protocol data unit comprising the data of the DRB.

In some embodiments, the network device is further caused to: instruct at least one serving cell associated with the RLC entity configured for the data of the DRB to maintain in the activated mode, and the at least one serving cell being configured with uplink transmission.

In some embodiments, the at least one serving cell is in a Timing Advance Group (TAG), and the TAG having a Time Alignment Timer (TAT) that is running.

In some embodiments, the at least one serving cell is configured with uplink transmission.

In some embodiments, a remaining duration of the activation procedure is smaller than a delay threshold predefined for an activation of the target secondary RLC entity.

In some embodiments, the network device is further caused to: determine whether there is a secondary RLC entity associated with a serving cell that is in an activated mode or in an activation procedure; and in accordance with a determination that there is no secondary RLC associated with a serving cell that is in an activated mode or in an activation procedure, activate no secondary RLC entity.

In some embodiments, the network device is caused to transmit the indication by: transmitting an uplink grant for the retransmission of the protocol data unit in a Physical Downlink Control Channel (PDCCH).

In some embodiments, the DRB is configured with a PDCP duplication which is based on an uplink grant for the retransmission of the protocol data unit.

In some embodiments, the at least one serving cell is configured as allowed serving cell for a logical channel of the target secondary RLC entity.

In some aspects, an apparatus implemented in a terminal device comprises: means for receiving an indication for a retransmission of a protocol data unit comprising data of a Data Radio Bearer (DRB); and means for activating, at the terminal device, a target secondary Radio Link Control (RLC) entity of one or more secondary RLC entities configured for the data of the DRB, the target secondary RLC entity being associated with at least one serving cell that is in an activated mode or in an activation procedure.

In some embodiments, the apparatus comprises means for determining whether there is a secondary RLC entity associated with a serving cell that is in an activated mode or in an activation procedure; and means for in accordance with a determination that there is no secondary RLC associated with a serving cell that is in an activated mode or in an activation procedure, activating no secondary RLC entity.

In some embodiments, the apparatus comprising: means for receiving an uplink grant for the retransmission of the protocol data unit in a Physical Downlink Control Channel (PDCCH).

In some embodiments, the apparatus comprising: means for indicating, to a upper layer, an activation of Packet Data Convergence Protocol (PDCP) duplication for the target secondary RLC entity, the upper layer comprising a PDCP layer.

In some embodiments, the at least one serving cell is configured as allowed serving cell for a logical channel of the target secondary RLC entity.

In some aspects, an apparatus implemented in a network device comprises: transmitting an indication for a retransmission of a protocol data unit comprising data of a Data Radio Bearer (DRB); and means for activating, at the network device, a target secondary Radio Link Control (RLC) entity of one or more RLC entities configured for the data of the DRB, the target secondary RLC entity being associated with at least one serving cell that is in an activated mode or in an activation procedure.

In some embodiments, the apparatus comprises: means for activating at least one serving cell associated with each of one or more secondary RLC entities configured for the data of the DRB in response to at least one of: scheduling a retransmission uplink grant for a protocol data unit comprising the data of the DRBprotocol data unit; transmitting the retransmission uplink grant to the terminal device; and receiving, from an activated secondary RLC entity of the terminal device, the protocol data unit comprising the data of the DRB.

In some embodiments, the apparatus comprises: means for instructing at least one serving cell associated with the RLC entity configured for the data of the DRB to maintain in the activated mode, and the at least one serving cell being configured with uplink transmission.

In some embodiments, the apparatus comprises: means for determining whether there is a secondary RLC entity associated with a serving cell that is in an activated mode or in an activation procedure; and means for in accordance with a determination that there is no secondary RLC associated with a serving cell that is in an activated mode or in an activation procedure, activating no secondary RLC entity.

In some embodiments, the at least one serving cell is configured as allowed serving cell for a logical channel of the target secondary RLC entity.

In some aspects, a computer-readable storage medium having instructions stored thereon, the instructions, when executed on at least one processor, cause the least one processor to perform the steps of the preceding aspects.

1-41. (canceled)

42. A terminal device, comprising:
at least one processor; and
at least one memory including computer program code;
the at least one memory and the computer program code configured to, with the at least one processor, cause the terminal device to:
receive an indication for a retransmission of a protocol data unit comprising data of a Data Radio Bearer (DRB); and
activate, at the terminal device, a target secondary Radio Link Control (RLC) entity of one or more secondary RLC entities configured for the DRB, the target secondary RLC entity being associated with at least one serving cell that is in an activated mode or in an activation procedure.

43. The method of claim 42, wherein the at least one serving cell is in a Timing Advance Group (TAG), and the TAG having a Time Alignment Timer (TAT) that is running.

44. The terminal device of claim 42, wherein a remaining duration of the activation procedure is smaller than a delay threshold predefined for an activation of the target secondary RLC entity.

45. The terminal device of claim 42, the terminal device is further caused to:
determine whether there is a secondary RLC entity associated with a serving cell that is in an activated mode or in an activation procedure; and
in accordance with a determination that there is no secondary RLC associated with a serving cell that is in an activated mode or in an activation procedure, activate no secondary RLC entity.

46. The terminal device of claim 42, wherein the terminal device is caused to receive the indication by:
receiving an uplink grant for the retransmission of the protocol data unit in a Physical Downlink Control Channel (PDCCH).

47. The terminal device of claim 42, wherein the DRB is configured with a PDCP duplication which is based on an uplink grant for the retransmission of the protocol data unit.

48. The terminal device of claim 42, wherein the terminal device is further caused to:
indicate, to a upper layer, an activation of Packet Data Convergence Protocol (PDCP) duplication for the target secondary RLC entity, the upper layer comprising a PDCP layer.

49. The terminal device of claim 42, wherein the at least one serving cell is configured as allowed serving cell for a logical channel of the target secondary RLC entity.

50. A network device, comprising:
at least one processor; and
at least one memory including computer program code;
the at least one memory and the computer program code configured to, with the at least one processor, cause the network device to:
transmit an indication for a retransmission of a protocol data unit comprising data of a Data Radio Bearer (DRB); and
activate, at the network device, a target secondary Radio Link Control (RLC) entity of one or more RLC entities configured for the data of the DRB, the target secondary RLC entity being associated with at least one serving cell that is in an activated mode or in an activation procedure.

51. The network device of claim 50, the network device is further caused to activate at least one serving cell associated with each of one or more secondary RLC entities configured for the data of the DRB in response to at least one of:
scheduling a retransmission uplink grant for a protocol data unit comprising the data of the DRB;
transmitting the retransmission uplink grant to the terminal device; and
receiving, from an activated secondary RLC entity of the terminal device, the protocol data unit comprising the data of the DRB.

52. The network device of claim 50, the network device is further caused to:
instruct at least one serving cell associated with the RLC entity configured for the data of the DRB to maintain in the activated mode, and the at least one serving cell being configured with uplink transmission.

53. The network device of claim 50, wherein the at least one serving cell is in a Timing Advance Group (TAG), and the TAG having a Time Alignment Timer (TAT) that is running.

54. The network device of claim 50, wherein a remaining duration of the activation procedure is smaller than a delay threshold predefined for an activation of the target secondary RLC entity.

55. The network device of claim 50, the network device is further caused to:
determine whether there is a secondary RLC entity associated with a serving cell that is in an activated mode or in an activation procedure; and
in accordance with a determination that there is no secondary RLC associated with a serving cell that is in an activated mode or in an activation procedure, activate no secondary RLC entity.

56. The network device of claim 50, wherein the DRB is configured with a PDCP duplication which is based on an uplink grant for the retransmission of the protocol data unit.

57. The network device of claim 50, wherein the at least one serving cell is configured as allowed serving cell for a logical channel of the target secondary RLC entity.

58. A method implemented in a terminal device, comprising:
receiving an indication for a retransmission of a protocol data unit comprising data of a Data Radio Bearer (DRB); and
activating, at the terminal device, a target secondary Radio Link Control (RLC) entity of one or more secondary RLC entities configured for the data of the DRB, the target secondary RLC entity being associated with at least one serving cell that is in an activated mode or in an activation procedure.

59. The method of claim 58, wherein the at least one serving cell is in a Timing Advance Group (TAG), and the TAG having a Time Alignment Timer (TAT) that is running.

60. The method of claim 58, wherein the DRB is configured with a PDCP duplication which is based on an uplink grant for the retransmission of the protocol data unit.

61. The method of claim 58, further comprising:
indicating, to a upper layer, an activation of Packet Data Convergence Protocol (PDCP) duplication for the target secondary RLC entity, the upper layer comprising a PDCP layer.

62. The method of claim 58, wherein the at least one serving cell is configured as allowed serving cell for a logical channel of the target secondary RLC entity.
